(19) United States
(12) Patent Application Publication
(10) Pub. No.: US 2002/0125600 A1
(43) Pub. Date: Sep. 12, 2002

(54) Plastic recycling system and process

(76) Inventor: David Horne, Prospect (SA)

Correspondence Address: MICHAEL J. GROSS, SHOOK, HARDY & BACON L.L.P., 1200 Main Street, Kansas City, MO, 64105-2118, US

(21) Appl. No.: 09/999,734

(22) Filed: Oct. 24, 2001

Related U.S. Application Data
(60) Provisional application No. 60/244,649, filed on Oct. 31, 2000.

(51) Int. Cl. B29B 17/00; B29C 47/00; B29C 69/00

(52) U.S. Cl. 264/68; 264/140; 264/176.1; 264/920; 425/222

(57) ABSTRACT

The present invention provides a plastic recycling system, including a first granulator for reducing plastic waste to a first particle size. The system also includes a second granulator for reducing plastic waste to a second particle size. A frictional melting structure is provided which melts the first particles and the second particles via use of a rotating plate.

### TECHNICAL FIELD

This invention relates to a system and process for recycling plastic waste into a usable item.

### BACKGROUND OF THE INVENTION

Plastic waste has become a serious community waste problem accounting for up to fourteen percent (14%) of a landfill. As is apparent, this large volume of plastic waste consigned to a landfill has a very low degradation rate, thus potentially creating environmental problems for the landfill.

In the past, there have been numerous attempts to recycle plastic waste into usable and sellable products. These recycling efforts usually resulted in very complex systems which required specific sorting of the particular types of plastic waste and separate processing of the specific types of plastic waste. More particularly, none of the prior recycling systems allowed processing of different types of plastic waste together to end up with a usable recycled product. Still further, many prior systems required washing or chemical treatment of the plastic waste.

Additionally, many of the past recycling systems resulted in unacceptable levels of chlorine gas being released to the atmosphere due to the overheating of polyvinylchlorides (PVC).

Therefore, a recycling system is needed which overcomes the problems discussed above.

### SUMMARY OF THE INVENTION

One object of the present invention is to provide a processing system which recycles all plastic waste and utilizes troublesome waste product in a productive manner.

A further object of the present invention is to provide a process and system which does not detrimentally affect or release into the environment harmful pollutants.

A still further aspect of the present invention is to provide a process and system which results in end products that are environmentally friendly and one hundred percent recyclable themselves.

A still further object of the present invention is to provide a process and system which does not require chemicals or any other treatment or washing of waste during the process and recycling of the plastics.

Accordingly, the present invention provides for a recycling system, including a first granulator for reducing plastic waste to a first particle size, and a second granulator for reducing plastic waste to a second particle size. The system also provides a frictional melting structure which melts said first particles and said second particles via use of a rotating plate.

The present invention also provides for a plastic melting structure including a housing having an inlet area and an exit area. A rotatable friction plate is positioned within said housing and is rotatably driven to provide melting of plastic via friction. The rotatable friction plate includes a plurality of raised friction structures positioned on said plate to further enhance the frictional melting of plastic waste.

The invention also provides for a granulator for plastic material, including a housing having an inlet and an outlet. A horizontally disposed rotor is positioned in said housing and has a longitudinal axis about which the rotor rotates. The rotor includes a plurality of rotating blades positioned generally parallel to the rotating axis of the rotor. At least two stationary blades are disposed on the housing at generally opposite locations from one another and on opposite sides of the rotor. A pinching action between the rotating blades and the stationary blades results in reduction of the particle size of the plastic material introduced into the inlet. A screen is positioned along at least a portion of the lower periphery of the rotor which allows only plastic particles of a particular size to pass therethrough, such that particles can be exited through the outlet of the housing.

The present invention also provides for a process for recycling plastic waste, including the step of first granulating the plastic waste. Thereafter, the plastic waste is melted via a friction or rotating plate. Thereafter, the plastic is molded into a suitable form.

Additional objects, advantages, and novel features of the invention will be set forth in part in the description which follows, and in part will become apparent to those skilled in the art upon examination of the following, or may be learned by practice of the invention.

### BRIEF DESCRIPTION OF THE DRAWINGS

In the accompanying drawings which form a part of the specification and are to be read in conjunction therewith and in which like reference numerals are used to indicate like parts in the various views:

FIG. 1 is a top perspective view of the recycling system according to the present invention;

FIG. 2 is a top plan view of the recycling system of FIG. 1;

FIG. 3 is a side elevational view of a portion of the recycling system of FIG. 1;

FIG. 4 is an elevational view of the storage site, agglomerator and trommel screen of the recycling system of FIG. 1;

FIG. 5 is a top plan view of the agglomerator of the recycling system of FIG. 1;

FIG. 6 is a cross-sectional view taken generally along line 6-6 of FIG. 5 showing the agglomerator plate and the screw structures of the present invention;

FIG. 7 is a cross-sectional view taken generally along line 7-7 of FIG. 6 and showing the internal structures of the agglomerator;

FIG. 8 is a top plan isolated view of an agglomerator block used and positioned on top of an agglomerator plate;

FIG. 9 is a cross-sectional view taken generally along line 9-9 of FIG. 8;

FIG. 10 is a cross-sectional view taken generally along line 10-10 of FIG. 3; and

FIG. 11 is a cross-sectional view taken generally along line 11-11 of FIG. 10;

### DETAILED DESCRIPTION OF THE PREFERRED EMBODIMENTS

The recycling system and process of the present invention is suitable for numerous different types of plastics. Table 1 below indicates the various types of plastics that can be recycled together in the system of the present invention and typical sources of those types of plastics and their abbreviated names.

TABLE 1

| | ABBRE- | |
|---|---|---|
| FORMAL NAME | VIATION | SOURCE |
| Polystyrene | PS | butter, margarine containers, |
| | | drink cups, foam used for |
| | | packing |
| Polyvinylchlorides | PVC | biscuit trays, packaging, garden |
| | | hoses, electric appliance parts |
| Polypropylene | PP | bottle caps, food containers, ice |
| | | cream containers & lids, plant |
| | | pots, rubbish bins, potato chip |
| | | bags, chairs, money, bale twine |
| Polyethylene | LDPE | shopping bags, newspaper wrap, |
| | LLDPE | toothpaste tubes, cling film, |
| | HDPE | shampoo containers, milk |
| | | containers, cream containers, |
| | | bread bags, milk bottles, bubble |
| | | wrap, stretch film from around |
| | | pallets, black plastic, wine& |
| | | water bladders |
| Polyethylene | PET | soft drink bottles |
| Terephthalate | | |

In general, it has been found that the makeup of plastic waste arising in the domestic waste stream of advanced industrial countries is substantially similar. More specifically, Table 2 below indicates the makeup of various plastics in an advanced industrial country.

TABLE 2

| | | PERCENT- |
|---|---|---|
| POLYMERS | SUBGROUPS | AGE |
| Polyolefin | Polyethylene PET, LLDPE, LDPE, HDPE, | 68% |
| | Polypropylene | |
| Styrene | (GP( (HI) Foamed | 12% |
| PVC | | 6% |
| Others | Nylons, Polycarbonates, Thermosets, etc. | 14% |

The present invention allows the commingling of these plastics into a feed stock mix which is melted to produce commercially usable products. The process preferably requires raw material predominantly from domestic waste and the addition of some selected industrial waste as appropriate. More specifically, the feed stock for the present inventive process basically requires a polyolefin content above forty percent (40%), with the remainder of the material made up of polymer types, such as PVC, nylons, styrene, provided that PVC does not exceed fifteen percent (15%) of the total. The requirement that PVC does not exceed fifteen percent (15%) of the total is to ensure that inappropriate levels of chlorine gas are not exerted to the environment through the process.

The recycling system of the present invention can be used to manufacture numerous different products, for instance, but not limited to, vineyard posts, oyster posts, pipe supports, slats, spat trays, manhole covers, and railroad ties. This list of items should in no way be construed as limiting the application of the present recycling system.

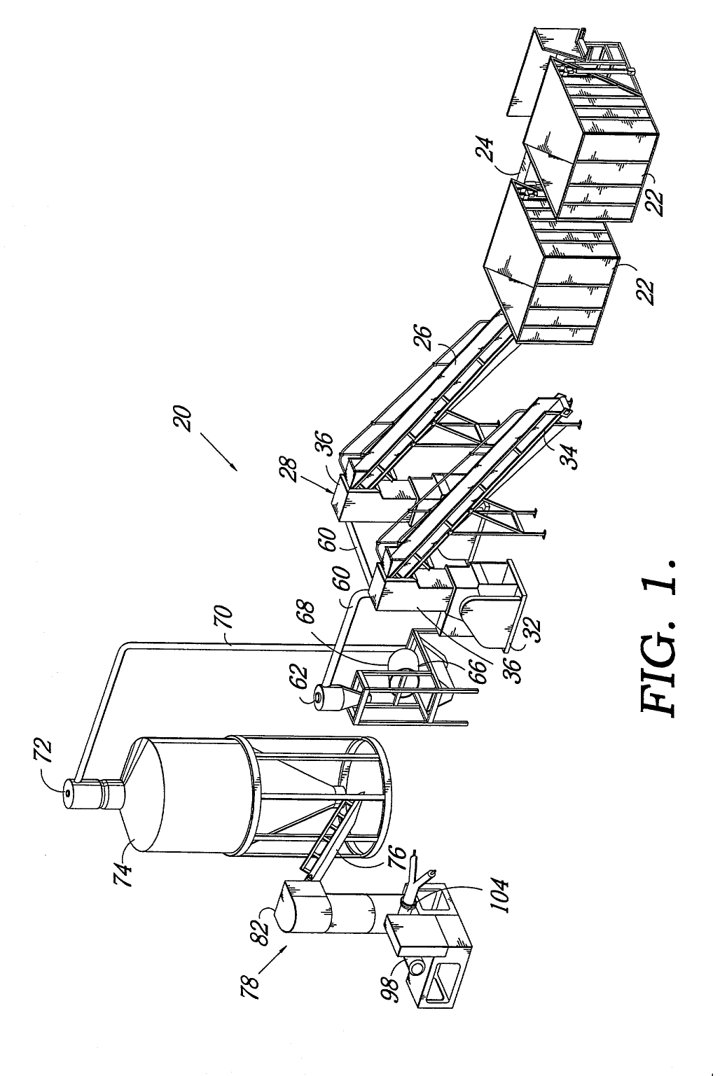

With reference to FIG. 1, a recycling system 20 according to the present invention is shown. System 20 includes recycled waste hoppers 22. Hoppers 22 can be hydraulically activated to tilt upwardly so that waste within hoppers 22 can be manually pulled onto sorting conveyor 24. Conveyor 24 is used to convey recyclable material to a feed conveyor 26 which, in turn, conveys the material to a primary granulator 28. To ensure that metal is removed prior to the recyclable material being conveyed to granulator 28, a large magnetic roller 30 can be positioned toward the end of conveyor 24 in a manner that is well-known in the art which will remove all ferrous material. Additionally, stainless steel objects will be removed via manual inspection on conveyor 24.

Again, with reference to FIG. 1, in addition to primary granulator 28, there is a secondary granulator 32. The provision of two separate granulators 28 and 32 allows for even melting of diverse plastic materials. More specifically, it has been recognized as part of the present invention that, if only one granulator is used, thus resulting in the plastic recyclable material being reduced to one particular size, a plastic film material would heat and melt at a much quicker rate than a heavier walled polymer material. Accordingly, it has been found advantageous to have two granulators 28 and 32 to deal with the different wall thickness of materials. More specifically, film grade material is dealt with in granulator 28, and results in material or particles not greater than twenty (20) square millimeters in size. The heavy-walled polymer materials are separated out from hoppers 22 manually, and are positioned on feed conveyor 34 which propels the materials to granulator 32. Granulator 32 reduces these thicker, heavier-walled materials to seven (7) square millimeter particles. As discussed above, this different treatment of film grade and thick-walled materials ensures that when the particles are melted later, they are melted in a consistent manner.

The operation of granulators 28 and 32 are the same, except for that granulator 32 reduces particles to a smaller size. Therefore, a discussion of granulator 28 will be put forth with the understanding that the operation of granulator 32 is identical, unless pointed out otherwise.

With reference to FIGS. 1, 10 and 11, the operation of granulator 28 will be described. Granulator 28 includes an upper feed shoot 36 which funnels recyclable material to a rotor 38. With reference to FIGS. 10 and 11, rotor 38 is driven by any suitable electric or internal combustion engine at a particular speed. Rotor 38 consists of six (6) rotating wheels 40 positioned on a driven shaft 42. It is shaft 42 that is coupled with the suitable driving structure in a manner that is well-known in the art. With reference to FIGS. 10 and 11, each set of three wheels 40 has positioned thereto a rotating blade 44 by any suitable attaching means, for instance, bolts 46. More specifically, wheels 40 are aligned with one another, such that to take up the entire longitudinal distance from the first wheel 40 to the end wheel 40, two (2) rotary blades 44 are used. In addition to rotary blades 44 positioned on wheels 40, stationary blades 48 are also utilized. It is the counterclockwise rotation of rotor 38 in FIG. 11 that results in a pinching or scissors action between rotating blades 44 and stationary blades 48 which results in the granulation of the plastic material. In order to ensure that the plastic material is reduced to a particular size, a mesh screen 50 of suitable size is utilized. More specifically, screen 50 only allows granulated materials to pass therethrough if they are of a particular size. Therefore, the plastic material is ground through the interaction and scissors action of rotating blades 44 and stationary blades 48, until such time as they are of a suitable size to pass through mesh 50 into particle storage area 52.

The construction of the present granulators with the scissors action between rotating blades 44 and stationary blades 48 offers a distinct advantage over granulators of the past which utilized a guillotine action. More specifically, it is known that film grade polymer material is difficult to granulate because of its molecular structure. Its molecular makeup produces a soft sticky structure that is hard to cut. The scissors action between blades 44 and blades 48 gives a much more efficient or optimal cutting than a chopping action. Adjusting screw 54 can be utilized to move mesh screen 50 closer or further away from rotor 38 to get the desired separation action. Additionally, stationary blades 48 are connected to frame 54 of granulator 28 via bolts 56 that can be loosened and adjusted inwardly or outwardly, depending upon the desired separation action. After the material has been granulated and passed into storage area 52, it can be removed therefrom via an auger or other suction fan (not shown), via an outlet 58.

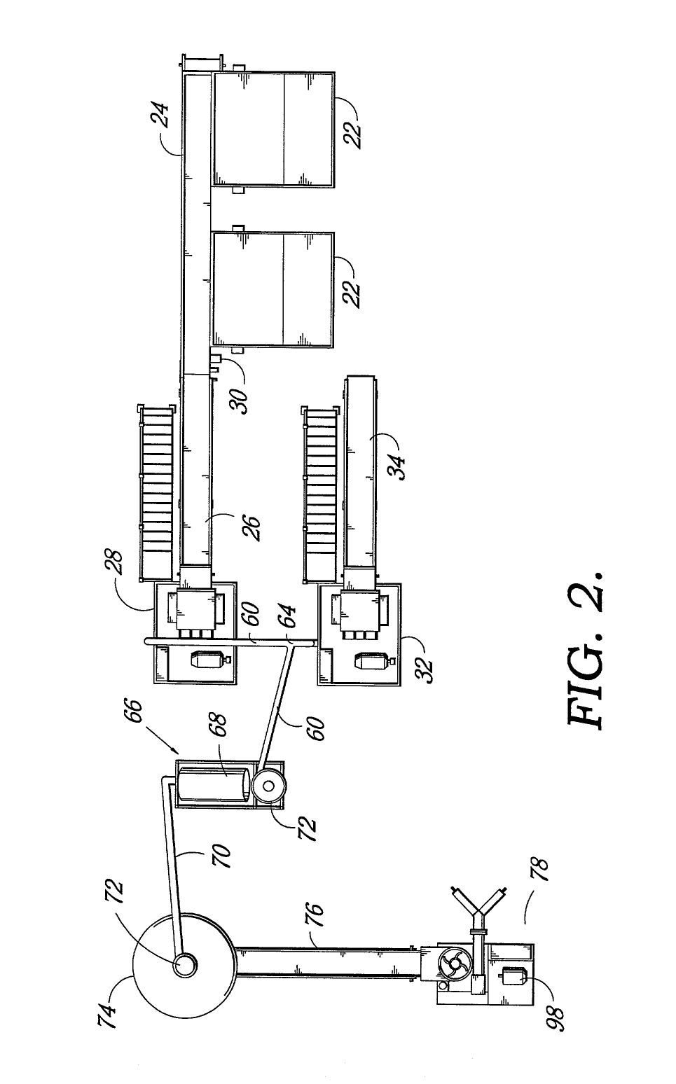

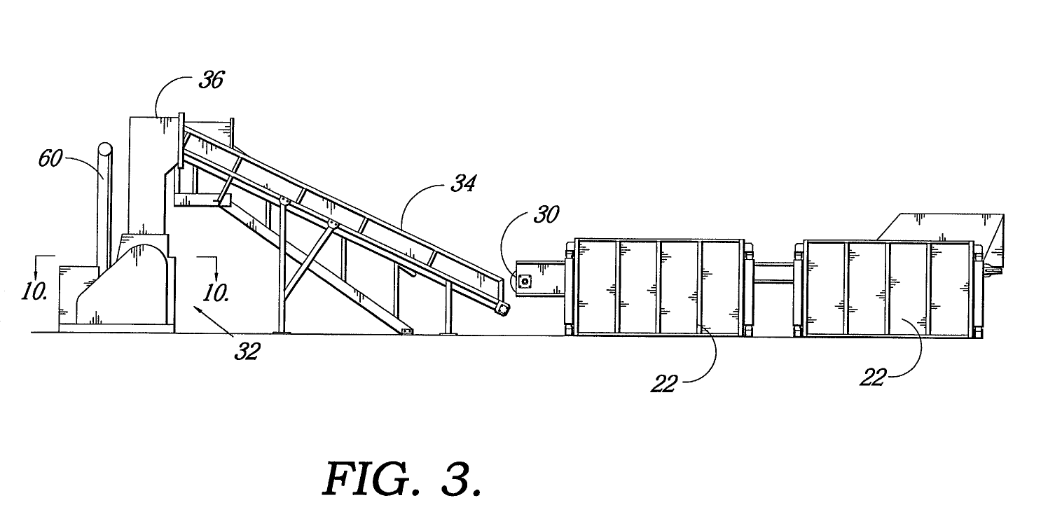

As mentioned above, the operation of granulator 32 is identical to the operation of granulator 28. Granulator 28, however, reduces particles to twenty (20) square millimeters, whereas granulator 32 reduces particles to seven (7) millimeters, for reasons as will be more fully described below. Once the granulated materials are removed from the storage areas 52 of the granulators, they are conveyed via suction fan, auger, or other suitable conveyance means through conveying conduits 60 to a cyclone separator 62. As best shown in FIG. 2, the conduits 60 join one another at a “T” area 64, wherein the seven (7) square millimeter particles and the twenty (20) square millimeter particles are combined before they are conveyed to cyclone 62.

Cyclone 62 results in separation of dirt from the plastic material, thus resulting in a cleaner recycled feed stock. In addition to separation of dirt from the recycled granulate at cyclone 62, the recycled material is also conveyed to a rotating trommel screen 66. More specifically, trommel screen 66 is a mesh screen that further results in separation of fine contaminants, such as dirt and food particles, from the granulate. The rotating screen 68 accomplishes this separation. Additionally, the granulate entering rotating screen 68 passes over a magnetic plate (not shown), which results in further removal of small still particles. Trommel screen 66 is desirable because the granulating process often results in an increased temperature of the waste plastics and thus dries off some of the moisture and releases these contaminants that are preferably removed before any sort of molding process. After the material exits trommel screen 66, it is conveyed pneumatically via conduit 70 and suction fan 72 to storage silo 74. Silo 74 is provided with an internal rotating auger to provide some blending and to facilitate smooth discharge of granulate onto feeding conveyor belt 76.

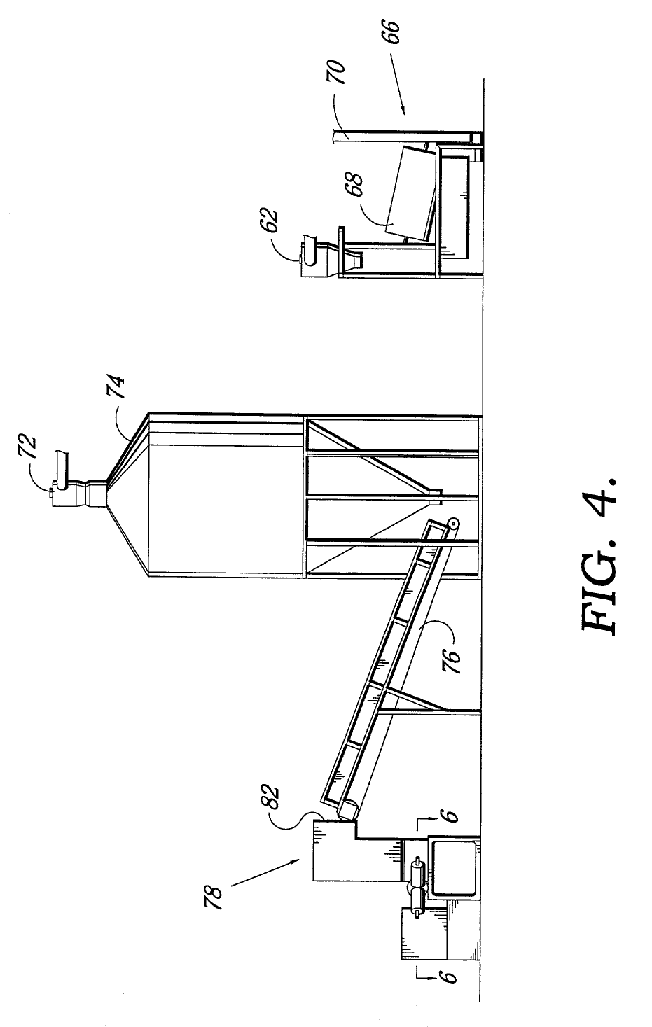

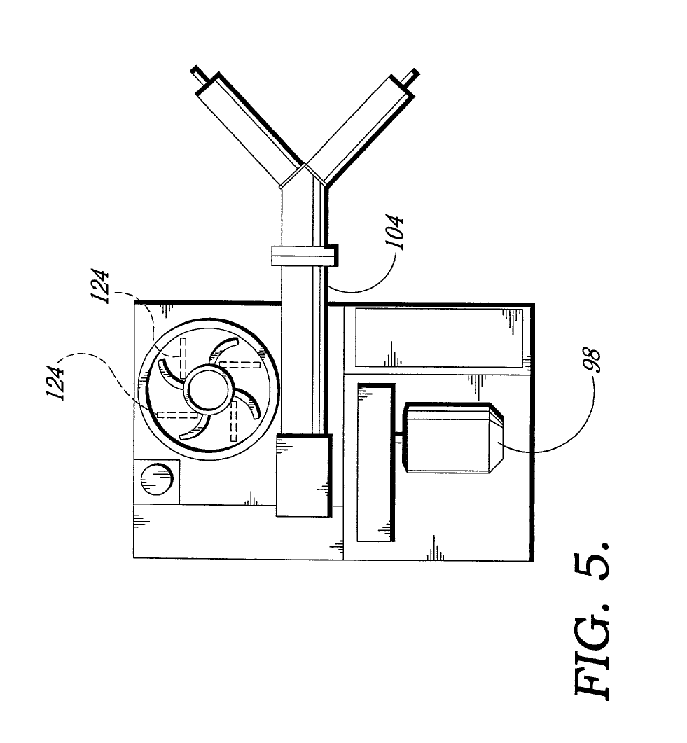

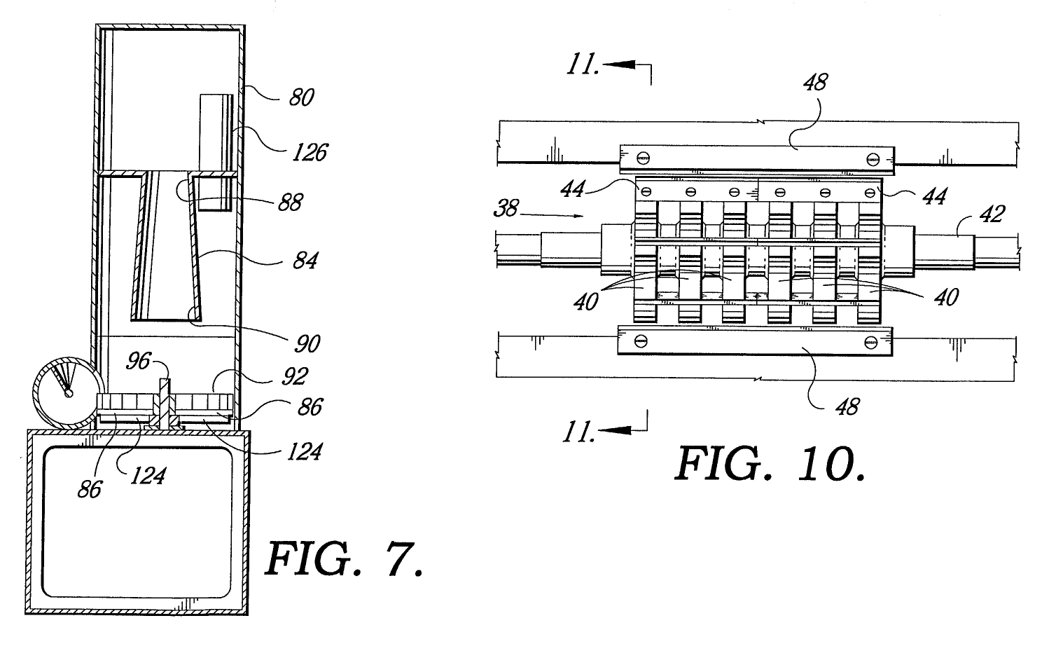

Conveyor 76 is used to feed agglomerator 78. It is within agglomerator 78 where the melting action takes place. With reference to FIGS. 5, 6 and 7, agglomerator 78 includes outer housing 80. Housing 80 includes an entrance chute 82 where the granulate is introduced into the housing via conveyor 76. Housing 80 includes a center cone structure 84 through which the granulate falls down through and onto the circular agglomerator rotor plate 86. More specifically, cone structure 84 has an inlet area 88 where particulate enters cone 84, and an outlet 90 positioned above plate 86, where the particulate then falls onto plate 86.

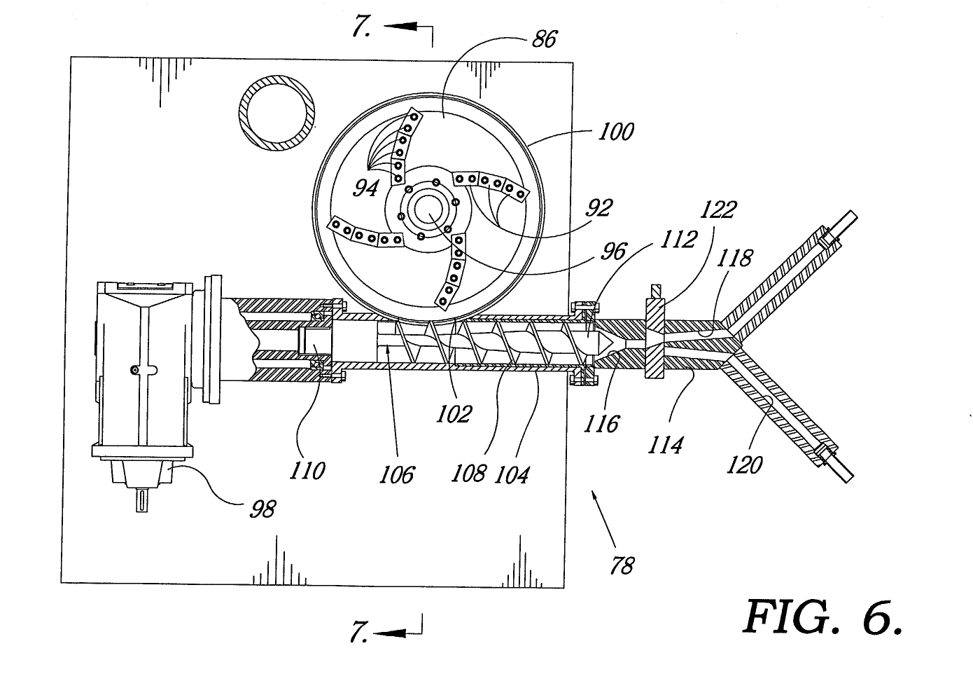

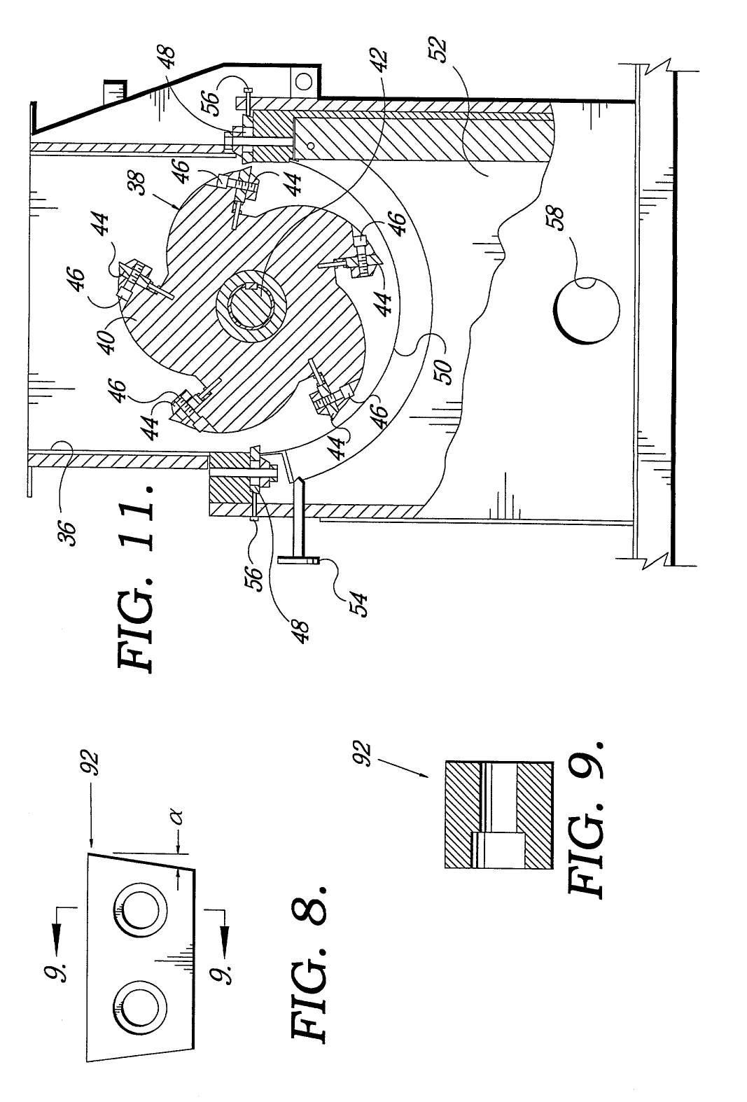

With reference to FIG. 6, rotor plate 86 has positioned thereon four (4) sets of three (3) agglomerator blocks 92. More specifically, blocks 92 are positioned to the top of plate 86, as shown in FIG. 6, wherein each spoke extending outwardly from the center of plate 86 is comprised of three (3) different blocks. FIGS. 8 and 9 show one of the agglomerator blocks 92. With reference to FIGS. 8 and 9, the agglomerator blocks are spaced equally about plate 86 in a spoke-like pattern. It has been found advantageous to have the edges of the agglomerator blocks have an angle of approximately 7.97 degrees. Additionally, blocks 92 preferably are approximately fifty (50) millimeters in width, fifty (50) millimeters in height, and ninety-eight (98) millimeters in length on the long side of block 92. The short side of block 92 is approximately eighty-four (84) millimeters. The dimensioning of the blocks in this manner has been found to provide adequate melting. Blocks 92 are positioned on the upper surface of plate 86 via bolts 94.

Plate 86 is rotated in a counterclockwise direction via center spindle 96 which is driven in a well-known manner from a drive motor 98. Lower housing 100 of agglomerator 78 is generally circular and contains plate 86. Additionally, plate 86 is spaced inwardly a slight distance from housing 100. Housing 100 is also connected at a periphery via opening 102 to screw barrel 104. Barrel 104 contains extruding screw 106 which has helical flighting 108 thereon to result in further compression and heating of plastic material, as will be further described below. Screw 106 is driven via drive train 110 and additionally driven by motor 98. Central shaft 112 of screw 106 gradually becomes larger in diameter as it moves away from lower housing 100, as is best shown in FIG. 6. Thereafter, extruding and diverter portion 114 is shown. More specific, portion 114 includes a central channel 126 which includes two different extruding pathways 118 and 120. As melted material passes through channel 116, it can be diverted to pathways 118 or 120 via diverter valve 122. Each extruding pathway 118 or 120 can be connected to any suitable mold. For example, a rotating mold for extruding vineyard poles could be used. Such a mold would generally consist of a cylinder wherein the extruded material is forced and thereafter cooled in a water bath to create a pole for a vineyard. Additional molds may be desired, and the invention should not be limited to any particular mold that comes after a particular pathway 118 or 120.

Rotator plate 86, in addition to blocks 92, also has positioned on a lower surface thereof veins 124. Veins 124 help create a vacuum which pulls material that passes through cone 84 toward rotor plate 86. Veins 124 can be equally spaced around plate 86, and can also be positioned, as shown in phantom lines in FIG. 5.

The provision of forming a vacuum below outlet 90 of cone 84 also results in air pressure being vented upwardly via vent pipe 126 positioned along the outer surface of cone 84. More specifically, the excess air pressure passes through pipe 126 to the upper enclosed chute 82, and ensures that any material suspended in the air in chute 82 is pushed downwardly toward inlet 88.

The operation of the recycling system will now be described. First of all, domestic waste is brought to the plant site, and is loaded into the various hoppers 22 via any suitable means, for instance, a front loader. Such waste can include the plastic materials described above in Table 1. Oftentimes, such waste includes fabric waste, which is uncontaminated waste from factories, which is normally clean, dry and available in large volumes of homogeneous-type materials. Such waste can also include industrial waste, which includes factory waste products, such as, shrink wrap, beverage crates, and drink bottles, and which is also available in large volumes of homogeneous material. The waste can also include post-consumer waste, which is normally contaminated with dirt, wood, metal, and rocks. The present invention enables all three types of waste to be processed without washing in one continuous operation, and without the use of added chemicals. The waste material is separated usually into three bays prior to being positioned in hoppers 22. A first bay or pile is composed mostly of LDPE, LLPDE, HDPE (all film grade materials). A second bay or pile is usually collected as all consumer waste. A third bay or pile can be composed of all industrial waste. A typical percentage-wise ratio for the recycling system is sixty percent (60%) from bay 1, thirty percent (30%) from bay 2, and ten percent (10%) from bay 3. Such ratio is determined by weight and not volume. Still further, the materials can generally be collected into two forms, a film grade and a thick-walled material.

In certain circumstances where the film grade material has HDPE in its composition, a following mix has been found to be desirable:

| | |
|---|---|
| Film grade | 10% by weight |
| LDPE/LLDPE | 50% by weight |
| Thick-walled material | 40% by weight |

After a sufficient mix has been provided, as discussed above, the mix is then loaded into one of hoppers 22 for granulation. As is apparent, the thick-walled materials themselves may not be loaded into one of hoppers 22, but may, however, be provided for loading on conveyor 34 which goes to granulator 32. Therefore, the thick-walled material would go directly onto conveyor 34 so that it can be granulated in granulator 32. The other material, the film grade material, is positioned in hopper 22. As mentioned above, the material in hopper 22 is loaded onto sorting conveyor 24, wherein large visible contaminants are removed. Additionally, ferrous materials can be removed by magnetic roller 30. Still further, large stainless steel pieces of material should be removed via hand from inspection conveyor 24. Thereafter, the material that has been inspected with the metal material removed is conveyed to feed conveyor 26 which goes to granulator 28. In granulator 28, the recyclable material is granulated to twenty (20) square millimeters, as described above. Still further, in granulator 32, as described above, the larger, heavier thick-walled materials are granulated or reduced to seven (7) square millimeter particles. Thereafter, the granulated materials are combined in “T” area 64 of conduit 60. Further dirt is separated from the materials in cyclone 62, and the materials are then passed through trommel screen 66. In trommel screen 66, further dirt is removed, and also a magnetic plate is used to remove further small metal pieces. Thereafter, the material is positioned in storage silo 74 via suction fan 72. The granulated material is then fed to agglomerator 78 via feed conveyor 76. The material exits feed conveyor 76 and flows downwardly through inverted cone 84 and onto rotor plate 86. On rotor plate 86 the material is heated via the rotation of the plate and the interaction of blocks 92 with the material. More specifically, rotor plate 86 preferably spins at 1480 revolutions per minute. The blocks 92 in conjunction with the speed of the rotor plate results in the material in the agglomerator being heated to 100° C. The blocks on the rotor plate and the plate coming into contact with the granulated material causes friction, which heats the particles to the required 100° C. for melting. The fused granules then form a mass encompassing the particles which have not fused at this temperature. Polymer granules, with a relatively high melting point, and PVC, stay in the mix encompassed by the melted and fused material rather like an aggregate in cement. As indicated above, the two granulators ensure that there is even melting. More specifically, having the thicker-walled materials in smaller sizes ensures that the heat applied by the friction in the agglomerator will result in melting at the same speed. If the weight-to-density ratio of the individual granules were too diverse, the thick-walled material particles would be quickly thrown to the outside of the chamber by the centrifuge action of the agglomerator without being adequately heated. At the same time, the film material would stay in the center for a long period of time, thereby overheating. By ensuring the different particle sizes for the film grade and the thick-walled material, such that they have the same molecular weights, the process ensures a more even melt is obtained.

As indicated above, the temperature of the mixed plastic in the agglomerator is basically kept at 100° C., but can be varied by the speed of screw 106. If the temperature in the bowl exceeds 100° C., the screw speed is automatically increased to take material away at a greater rate allowing more cold material to enter and cool the mix. In this way, the temperature in the agglomerator is basically kept at a constant 100° C.

A further advantage of the inventive process is that within the agglomerator, all the material blends together to form one malleable mass. The material that remains as solid material is encapsulated within and by the other material. As material is heated and becomes denser, it moves to the outside of the centrifuge along lower housing 110 and is picked up by screw 104 through opening 102. Screw 106 through its flighting 108 and shaft 112 places the material under further pressure. As the material moves into the screw, it is compressed, and the friction created by the compression heats the material by a further 40 degrees to approximately 140° C. The final heating completes the blending process and produces the product which is then expelled or forced under pressure through channel 116 and molding pathways 118 and 120 to the various molds for the various products.

A further aspect of the invention is that, because the temperature in the agglomerator and screw does not exceed 140° C., PVC does not commence degradation. Accordingly, no PVC molecules are released and, as a result, there is no migration of PVC molecules to attack the other polymers. Because the PVC is not degraded, it does not release chlorine gas; and, therefore, the process is very environmentally safe. As is apparent, the present invention provides for a system and process wherein plastic waste sourced from households, hospitals, and other industry can be mixed together with no separation or washing required. Additionally, paper labels and bottle tops present no problem with the system or process. As indicated above, metal from the raw material supply is the only sorting required. Foil and small aluminum containers are processed with the plastic waste and do not damage their granulator blades.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

I claim:

1. A plastic recycling system comprising:
a first granulator for reducing plastic waste to a first particle size;
a second granulator for reducing plastic waste to a second particle size; and
a frictional melting structure which melts said first particles and said second particles via use of a rotating plate.

2. The plastic recycling system of claim 1, further including an extruder structure connected to said melting structure for further melting said first and second particles together.

3. The plastic recycling system of claim 2, further comprising a rotating screen for removing contaminants from said first and second particles.

4. The plastic recycling system of claim 3, further comprising a magnetic structure over which said recycled waste is passed prior to entrance into said first granulator.

5. The plastic recycling system of claim 2, wherein said rotating plate further includes friction blocks positioned on the top surface thereof to increase said melting of said first and second particles via friction.

6. The plastic recycling system of claim 1, further including a storage silo for storing said first and second particles prior to said particles being introduced into said plastic melting structure.

7. A plastic melting structure comprising:
a housing having an inlet area and an exit area;
a rotatable friction plate disposed in said housing and rotatably driven to provide melting of plastic via friction; and
a plurality of raised friction structures positioned on said plate to further enhance the frictional melting of plastic.

8. The plastic melting structure of claim 7, further comprising an extruder screw positioned adjacent said outlet of said housing, such that plastic material is first melted via said rotating plate, and thereafter further melted via said extruding screw.

9. The plastic melting structure of claim 8, further comprising a cone positioned in said housing adjacent said inlet, such that plastic material to be recycled flows through said cone structure.

10. The plastic melting structure of claim 9, further comprising a vent conduit for venting excess air pressure from adjacent said rotor plate to a location adjacent said inlet, such that recyclable material is forced downwardly through said cone structure.

11. A granulator for plastic material comprising:
a housing having an inlet and an outlet;
a horizontally disposed rotor within said housing, said rotor having a longitudinal axis about which it rotates, said rotor further including a plurality of rotating blades positioned generally parallel to said rotating axis of said rotor;
at least two stationary blades disposed on said housing at generally opposite locations from one another and on opposite sides of said rotor, such that the pinching action between said rotating blades and said stationary blades results in reduction of particle size of plastic material introduced into said inlet; and
a screen positioned along at least a portion of the lower periphery of said rotor which allows only plastic particles of a particular size to pass therethrough, such that such particles can be exited through said outlet.

12. The granulator of claim 11, wherein said rotor includes a plurality of wheels, said rotating blades attached to said wheels.

13. A process for recycling plastic comprising:
granulating the plastic waste;
melting said plastic via a frictional rotating plate; and
molding said plastic into a suitable form.

14. The process of claim 13, further comprising extruding said recycled plastic after it has been melted by said rotating plate.

15. The process of claim 13, further comprising granulating said plastic waste into two separate particle sizes to enhance melting.

16. The process of claim 13, further comprising storing said granulated plastic material prior to melting said material prior to said melting step.

17. The process of claim 13, further comprising cleaning said granulated plastic material via a rotating screen prior to said melting step.
